(19) United States
(12) Patent Application Publication
(10) Pub. No.: US 2006/0279395 A1
(43) Pub. Date: Dec. 14, 2006

(54) Inductor and magnetic body thereof

(75) Inventors: Cheng-Hong Lee, Taoyuan Hsien (TW); Ming-Shan Shiu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/437,672

(22) Filed: May 22, 2006

(30) Foreign Application Priority Data
Jun. 10, 2005 (TW) 094119250

(51) Int. Cl. H01F 17/04; G11B 5/33

(52) U.S. Cl. 336/221; 336/219; 428/800; 336/231

(57) ABSTRACT

A magnetic body for a transforming device or a regulating device is formed by mixing a first magnetic material, a second magnetic material and a resin, and curing the mixture. The average particle size of the first magnetic material ranges from 35 μm to 125 μm and the average particle size of the second magnetic material is smaller than 35 μm.

### BACKGROUND OF THE INVENTION

1. Field of Invention

The invention relates to an inductor and the magnetic body thereof. More particularly, the invention relates to a high-efficiency inductor and the magnetic body thereof.

2. Related Art

In the trend of miniaturizing electronic device, some basic and important elements such as inductors are also required to reduce their volumes and masses. Therefore, it is the current goal to achieve small volumes for the elements while at the same time keeping their low loss and high efficiency properties.

The conventional inductor has an iron core and a coil surrounding the iron core. The iron core can be in the C-shaped, E-shaped, I-shaped, or a toroidal shape. FIG. 1 shows the exploded view of an E/I shaped inductor 1. The coil 11 is located between an E-shaped iron core 10 and an I-shaped iron core 10. The assembled inductor 1 is shown in FIG. 2. Finally, the inductor 1 is used in devices such as a surface mounted device (SMD).

Since the conventional inductor 1 is composed of individual components, there are, however, many air gaps in the assembled inductor 1. Therefore, the inductor 1 usually generates noises when operating at high frequencies. The air gaps also prevent the devices from miniaturization.

To solve the above problem, an inductor 2 with a single iron core has been disclosed in the prior art. As shown in FIG. 3, the inductor 2 has an iron core base 20, a coil 21, and an iron core cover 22. The iron core base 20 has a recess 201 and two openings 202. The coil 21 with a first end 211 and a second end 212 is disposed in the recess 201. The first end 211 and the second end 212 extend via the openings 202 of the iron core base 20 to form the two pins of the inductor 2. The iron core cover 22 is formed from magnetic powders by die casting to cover the coil 21. This case uses the single iron core to achieve the goal of no air gap in the inductor 2.

In addition to using the magnetic powders as the primary ingredient, the iron core cover 22 of the inductor 2 is usually added with a thermosetting resin as an insulating material to effectively reduce the core loss due to the eddy current loss. However, many factors such as the average particle size of the magnetic powders and the die casting quality of the iron core cover 22 may have different effects on the efficiency of the inductor 2. For example, magnetic powders with a too large average particle size will render an iron core cover that cannot withstand a large DC bias. On the other hand, if the average particle size of the magnetic powders is too small, the inductance and thus the efficiency of the inductor decrease. Besides, the thermosetting resin is likely to deteriorate under the heat generated by the inductor 2 in operation. Therefore, the lifetime of the inductor 2 gets shorter.

It is therefore an important subject of the invention to provide an inductor and a magnetic body thereof for solving the above mentioned problems.

### SUMMARY OF THE INVENTION

In view of the foregoing, the invention is to provide an inductor and the magnetic body thereof. By using the complex magnetic materials and the combination of different particle sizes thereof, the edge effect can be overcome to achieve higher inductance and longer device lifetime.

To achieve the above, a magnetic body of the invention for a transforming device or a regulating device is made by mixing a first magnetic material, a second magnetic material, and a resin, followed by a curing process. The average particle size of the first magnetic material ranges from 35 μm to 125 μm, and the average particle size of the second magnetic material is smaller than 35 μm.

To achieve the above, an inductor of the invention for a transforming device or a regulating device includes a coil and at least a magnetic body for covering the coil. The magnetic body is made by mixing a first magnetic material, a second magnetic material, and a resin, followed by a curing process. The average particle size of the first magnetic material ranges from 35 μm to 125 μm, and the average particle size of the second magnetic material is smaller than 35 μm.

In the invention, the resin can be a thermosetting resin or a photosetting resin.

As mentioned above, the inductor and the magnetic body thereof of the invention use the mixture of magnetic materials with different particle sizes and a resin to form the magnetic body. Since the complex magnetic materials overcome the possible edge effect or low the inductance due to a unique particle size as in the prior art, the inductor and magnetic body of the invention can therefore achieve a higher inductance and withstand a larger DC bias. Moreover, the resin may be made of nano-inorganic powders with high insulation and high thermal conductivity. In addition to the goals of increasing the DC bias and lower the eddy current loss, the resin deterioration problem of the prior art can be improved because of the increased thermal conductivity. Therefore, the inductor has a longer lifetime.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional inductor;

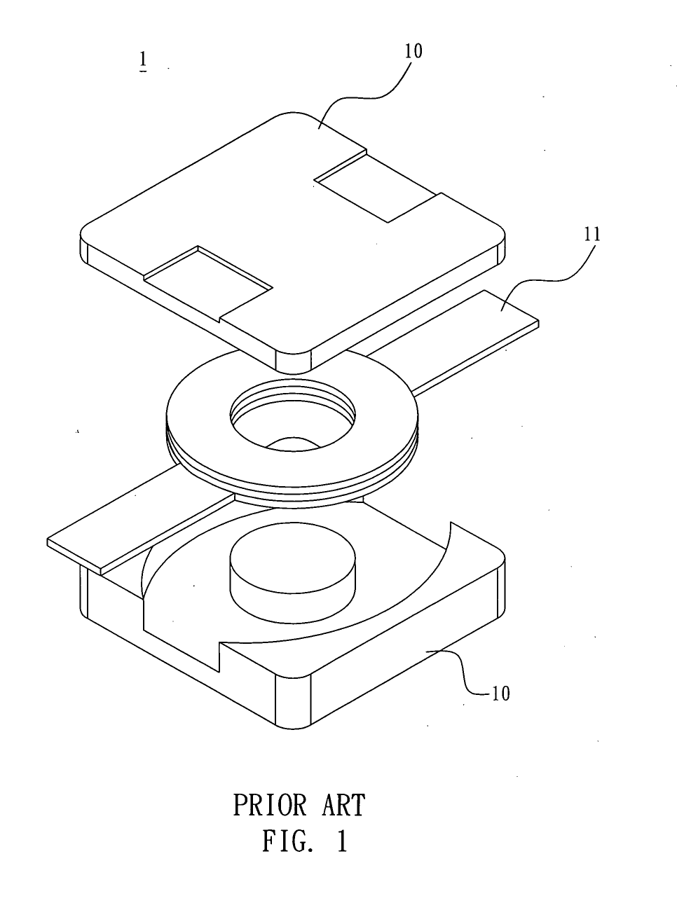

FIG. 2 is a schematic view showing the assembly of the conventional inductor;

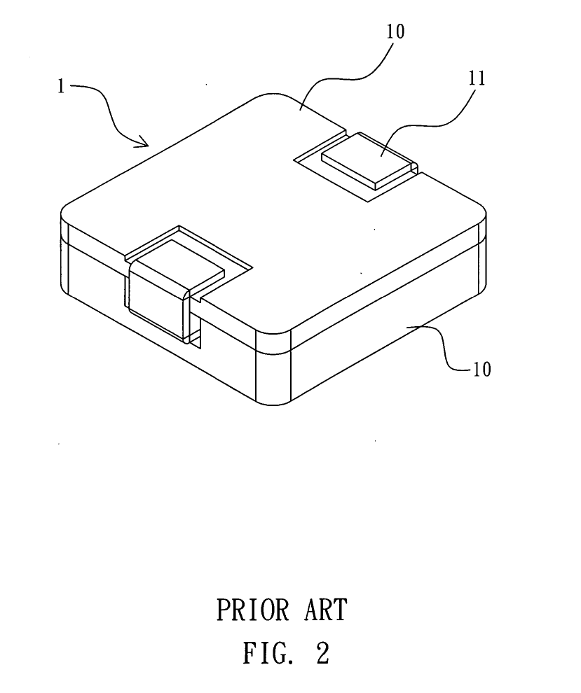

FIG. 3 is a schematic view of the conventional inductor with a single iron core; and

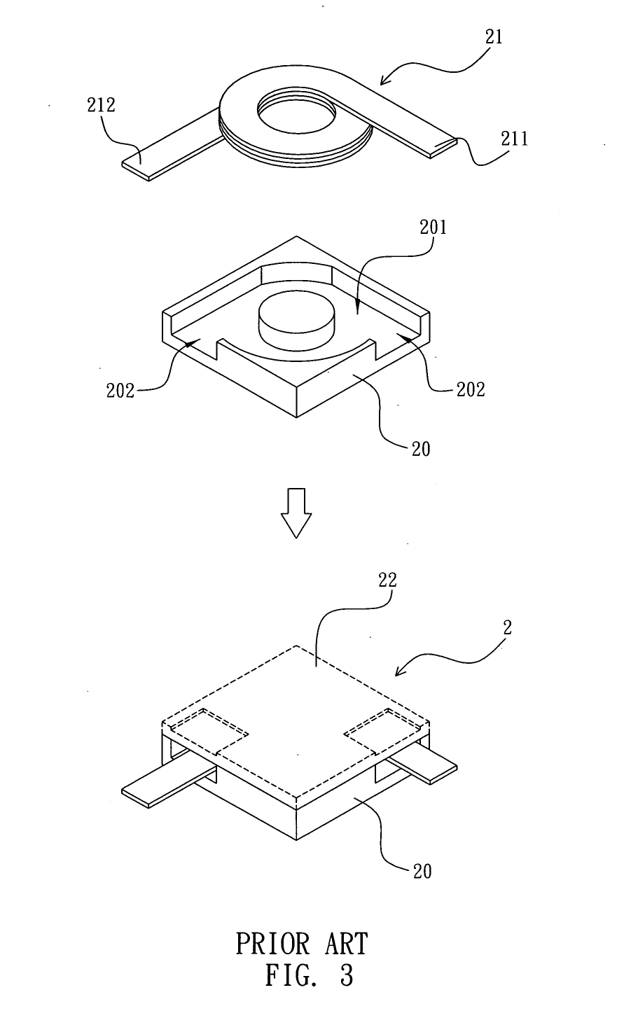

FIG. 4 is a schematic cross-sectional view of an inductor according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

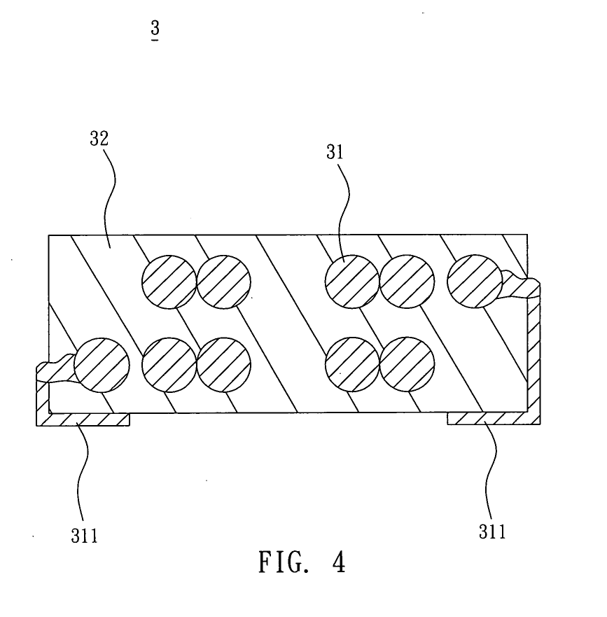

FIG. 4 shows a schematic cross-sectional view of an inductor 3 used in a transforming device or a regulating device. In the embodiment, the inductor 3 includes a coil 31 and at least a magnetic body 32.

The magnetic body 32 covers the coil 31. The coil 31 is made from a circular wire, square wire, or flat wire wound several turns. Both ends 311 of the coil 31 are led out of the magnetic body 32 to be the pins of the inductor 3.

The magnetic body 32 is made by mixing a first magnetic material, a second magnetic material, and a thermosetting resin, and then curing the mixture.

The average particle size of the first magnetic material ranges from 35 μm to 125 μm. The average particle size of the second magnetic material is smaller than 35 μm. The shape of the first magnetic material or the second magnetic material is spherical, sphere-like, or ellipsoidal. In this embodiment, the first magnetic material or the second magnetic material is Fe, Si, Co, Ni, Al, Mo, or combination thereof. More explicitly, the first magnetic material and the second magnetic material are not limited to the same kind of material. For example, the first magnetic material and the second magnetic material are both iron. Alternatively, the first magnetic material is a Fe—Si alloy, while the second magnetic material is iron.

As described above, in this embodiment, the magnetic materials with different average particle sizes are mixed to form a complex magnetic body. One may further control the particle shape of the magnetic material to enhance the inductance of the inductor 3. At the same time, the device can withstand a larger DC bias.

In the embodiment, the thermosetting resin is used as an insulating material to increase the current durability and to reduce the eddy current loss. The resin can be a nano-inorganic material whose average particle size is smaller than 1 μm and has high insulation capability and high thermal conductivity. The nano-inorganic material is, for example, AlN, SiC, BN, BeO, Sio₂, Al₂O₃ and diamond. Besides, the resin may be a photosetting resin too.

In summary, the inductor and the magnetic body thereof of the invention use the mixture of magnetic materials with different particle sizes and a resin to form the magnetic body. Since the complex magnetic materials overcome the possible edge effect or low the inductance due to a unique particle size as in the prior art, the inductor and magnetic body of the invention can therefore achieve a higher inductance and withstand a larger DC bias. Moreover, the resin may be made of nano-inorganic powders with high insulation and high thermal conductivity. In addition to the goals of increasing the DC bias and lower the eddy current loss, the resin deterioration problem of the prior art can be improved because of the increased thermal conductivity. Therefore, the inductor has a longer lifetime.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A magnetic body comprising:
a first magnetic material with an average particle size ranged between 35 μm and 125 μm;
a second magnetic material with an average particle size smaller than 35 μm; and
a resin, wherein the magnetic body is formed by mixing the first magnetic material, the second magnetic material, and the resin and curing.

2. The magnetic body of claim 1, wherein the first magnetic material or the second magnetic material is Fe, Si, Co, Ni, Al, Mo, or the combination thereof.

3. The magnetic body of claim 1, wherein the shape of the first magnetic material or the second magnetic material is a sphere, a sphere-like shape, or an ellipsoid.

4. The magnetic body of claim 1, wherein the resin is a nano-inorganic material.

5. The magnetic body of claim 4, wherein the nano-inorganic material has high insulation capability and high thermal conductivity.

6. The magnetic body of claim 4, wherein an average particle size of the nano-inorganic material is smaller than 1 μm.

7. The magnetic body of claim 4, wherein the nano-inorganic material is AlN, SiC, BN, BeO, SiO₂, Al₂O₃ or diamond.

8. The magnetic body of claim 1, wherein the resin is a thermosetting resin or a photosetting resin.

9. An inductor, comprising:
a coil; and
at least one magnetic body for covering the coil, wherein the magnetic body is formed by mixing a first magnetic material, a second magnetic material, and a resin, and curing, wherein the first magnetic material and the second magnetic material have different average particle sizes.

10. The inductor of claim 9, wherein the average particle size of the first magnetic material ranges from 35 μm to 125 μm, and the average particle size of the second magnetic material is smaller than 35 μm.

11. The inductor of claim 9, wherein the first magnetic material or the second magnetic material is Fe, Si, Co, Ni, Al, Mo, or the combination thereof.

12. The inductor of claim 9, wherein the shape of the first magnetic material or the second magnetic material is a sphere, a sphere-like shape, or an ellipsoid.

13. The inductor of claim 9, wherein the resin is a nano-inorganic material.

14. The inductor of claim 13, wherein the nano-inorganic material has high insulation capability and high thermal conductivity.

15. The inductor of claim 13, wherein the average particle size of the nano-inorganic material is smaller than 1 μm.

16. The inductor of claim 13, wherein the nano-inorganic material is selected from the group consisting of AlN, SiC, BN, BeO, SiO₂, Al₂O₃ and diamond.

17. The inductor of claim 9, wherein the resin is a thermosetting resin or a photosetting resin.

18. The inductor of claim 9, wherein the coil is a circular wire with many turns, a square wire with many turns, or a flat wire with many turns.
